(19) United States
(12) Patent Application Publication
(10) Pub. No.: US 2004/0005151 A1
(43) Pub. Date: Jan. 8, 2004

(54) Gateway network element for providing automatic level control and error monitoring

(76) Inventor: Donald Pitchforth JR., Rockwall, TX (US)

Correspondence Address: WORLDCOM, INC., Technology Law Department, 1133 19th Street, N.W., Washington, DC, 20036, US

(21) Appl. No.: 10/187,198

(22) Filed: Jul. 2, 2002

(51) Int. Cl. H04B 10/02; H04B 10/16

(52) U.S. Cl. 398/37; 398/38; 398/177

(57) ABSTRACT

An approach for providing transmission level control in an optical network having an amplifier chain is disclosed. An optical communications system includes a gateway network element configured to receive an amplifier requirement from a host. The system also includes a network element communicating with the gateway network element over an optical amplifier chain, the network element being configured to receive the amplifier requirement from the gateway network element, and to adjust transmission power level in response to the amplifier requirement (e.g., error rate information including Signal-to-Noise (S/N) ratio, bit error rate (BER), and/or Quality (Q) value).

### FIELD OF THE INVENTION

The present invention generally relates to optical networks, and more particularly, to performing automatic level control and error monitoring.

### BACKGROUND OF THE INVENTION

With the emergence of new and sophisticated network services and computing applications, consumers continually demand greater and greater bandwidth, requiring network providers to move from conventional bandwidth constrained systems to fiber optic communications networks. Fiber optic communications networks provide higher capacity for bandwidth intensive applications, such as advanced digital services, high-speed Internet access, video on demand, interactive multimedia, etc., as compared to conventional networks. These fiber optic communications networks offer several inherent engineering advantages over copper-based networks. For example, data transported in fiber optic communications networks is immune from electrical interference and does not radiate energy outside the fiber optic cladding, thereby minimizing signal distortion and increasing security. Accordingly, network providers have invested in deploying optical systems to address the bandwidth demands.

In modern optical communications systems, a number of network components with varying specifications and manufacturers are used. These network components, for example, include dispersion compensation modules, multiplexer modules, de-multiplexer modules, couplers, line amplifiers, post-amplifiers, pre-amplifiers, transmitters, and receivers. Undoubtedly, the functionality and complexity of these components are likely to increase with the advent of new technologies.

For instance, thin film technology has enabled the creation of multiplexer and demultiplexer modules as well as narrow band lasers, allowing numerous transmitter/receiver pairs to be placed on a single amplifier and fiber, thereby increasing system capacity. By contrast, older generation optical systems employ a single transmitter/receiver pair for each amplifier. With the increase in transmitter/receiver pairs, transmission level control across the network is vital for proper operation and improved performance.

Concomitant with the improvement in capacity, however, various engineering hurdles need to be overcome. In particular, noise generated by the amplifiers, unequal amplification across wavelengths, and non-linear effects of the signals being too high and unequal (affecting dispersion across the wavelengths) adversely impact network operation and performance. Traditionally, some of these problems have been addressed with discrete components designed to address individual problems. For example, sloped dispersion compensation components are used to correct for unequal dispersion. The manner in which these design issues is addressed effectively determines the distance that the traffic may traverse before amplification and/or regeneration is required.

To amplify optical signals across the network, open amplifier chains are typically deployed in such systems. Open amplifier chains may be optical Dense Wavelength Division Multiplexing (DWDM) systems with optical amplifiers that are not line terminated. One significant drawback in such an open system is that the wavelengths are not controlled as a group, but individually. These design problems are further exacerbated by the fact that frequently different manufacturers of equipment, particularly for the amplifier chain of the optical network, are used to construct the optical network. As a result, the capability for such equipment to communicate with each other is largely impractical.

Therefore, optical span budgets may not be fully optimized, which results in oversizing (i.e., greater than necessary optical span budgets are utilized), thereby increasing cost. For example, line terminating equipment (LTE) can be “free running” with respect to transmission levels. In other words, each network element may be performing a specific function without ever communicating or being aware of the other network elements' operation. Line terminating equipment may not provide feedback regarding other systems on the same amplifier chain and error rates of the line terminating equipment.

From the above discussion, traditionally, the active components of a network transmission system do not exchange information regarding transmission quality and level. Under the conventional approach, when an amplifier chain is installed, a technician is used to manually test each component of the system as well as end-to-end performance of the system. In some cases, on-board optical power meters are utilized, permitting a technician to determine power levels of the components of the system.

Fiber optic networks can be used in a range of environments, including local area networks (LANs), metropolitan area networks (MANs), and wide area networks (WANs), as well as Long Haul (LH) and Ultra Long Haul (ULH) environments. In a metropolitan environment, data travels within relatively short distances among nodes in the optical network. In the LH and ULH environments, optical networks typically can transport data over thousands of kilometers. Given their geographically broad coverage, LH and ULH networks utilize a multitude of optical amplifiers to maintain acceptable signal levels. Accordingly, the engineering challenges of line equalization are acute in these environments.

Therefore, there is a need for performing automatic level control and error monitoring to enhance network performance in an optical network. There is also a need for efficiently utilizing network resources. There is also a need to provide flexibility in network design to deploy equipment manufactured from different vendors.

### SUMMARY OF THE INVENTION

The above and other needs are addressed by the present invention, which provides an improved method and system for performing measurements in an optical network. A gateway network element functionality is introduced to communicate amplifier requirements (e.g., Signal to Noise (S/N) ratio, bit error rate (BER), Quality (Q) value, etc.), which can be based on error rates, to another network element for automatically controlling the transmission level across an optical amplifier chain. This arrangement advantageously enhances network performance and improves system efficiency.

Accordingly, in one aspect of an embodiment of the present invention, a method for providing transmission level control in an optical network having an amplifier chain is disclosed. The method includes receiving an amplifier requirement from a host; and forwarding the amplifier requirement to a network element in the optical network. The network element adjusts transmission power level in response to the amplifier requirement.

According to another aspect of an embodiment of the present invention, a network device for providing transmission level control in an optical network having an amplifier chain is disclosed. The device includes logic configured to receive an amplifier requirement from a host. The device also includes a controller coupled to the logic and configured to control a transmitter, wherein the transmitter is configured to forward the amplifier requirement to a network element in the optical network, and the network element adjusts transmission power level in response to the amplifier requirement.

According to another aspect of an embodiment of the present invention, a system for providing transmission level control in an optical network having an amplifier chain is disclosed. The system includes means for receiving an amplifier requirement from a host; and means for forwarding the amplifier requirement to a network element in the optical network. The network element adjusts transmission power level in response to the amplifier requirement.

According to another aspect of an embodiment of the present invention, an optical communications system includes a first network element configured to receive an amplifier requirement from a host. The system also includes a second network element communicating with the first network element over an amplifier chain. The second network element is configured to receive the amplifier requirement from the first network element, and to adjust transmission power level in response to the amplifier requirement.

According to another aspect of an embodiment of the present invention, a method for providing transmission level control in an optical network is disclosed. The method includes accessing a gateway network element associated with a line terminating equipment of the optical network; and transmitting an amplifier requirement to the gateway network element. The gateway network element forwards the amplifier requirement to another line terminating equipment over an amplifier chain in the optical network. The other line terminating equipment adjusts transmission power level in response to the amplifier requirement.

In yet another aspect of an embodiment of the present invention, a computer-readable medium carrying one or more sequences of one or more instructions for providing transmission level control in an optical network is disclosed. The one or more sequences of one or more instructions include instructions which, when executed by one or more processors, cause the one or more processors to perform the step of accessing a gateway network element associated with a line terminating equipment of the optical network. Another step includes transmitting an amplifier requirement to the gateway network element, wherein the gateway network element forwards the amplifier requirement to another line terminating equipment over an amplifier chain in the optical network. The other line terminating equipment adjusts transmission power level in response to the amplifier requirement.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of an optical network utilizing a gateway network element (GNE) to perform automatic level control and error monitoring, in accordance with an embodiment of the present invention;

FIG. 2 is a diagram of a line terminating equipment (LTE) capable of providing gateway network element functionality, according to an embodiment of the present invention;

FIG. 3 is a flow chart of the operation of the system of FIG. 2 for performing equalization, according to an embodiment of the present invention; and

FIG. 4 is an exemplary computer system that can be programmed to perform one or more of the processes, in accordance with various embodiments of the present invention.

### DESCRIPTION OF THE PREFERRED EMBODIMENTS

A method, system, and software for providing automatic level control and error monitoring in an optical network are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

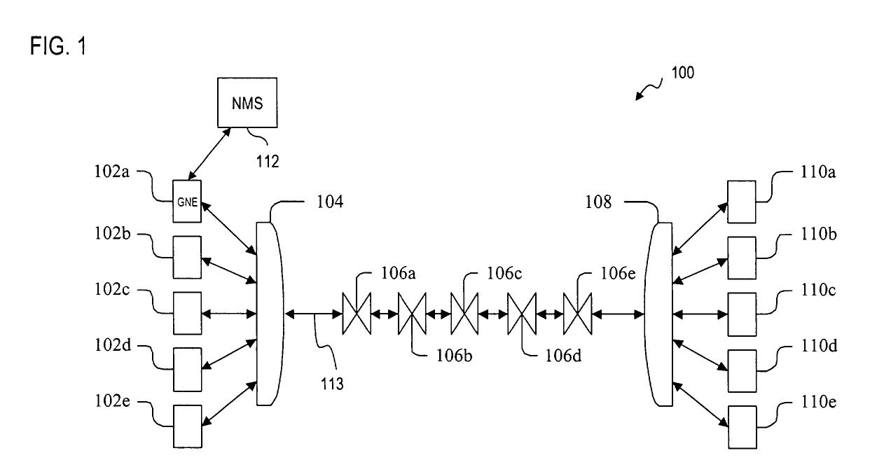

FIG. 1 is a diagram of an optical network utilizing a gateway network element (GNE) to perform automatic level control and error monitoring, in accordance with an embodiment of the present invention. An optical system 100 includes, for example, an optical amplifier chain (formed by optical amplifiers 106a-106e) that is terminated with network elements 102a-102e and 110a-110e. Multiplexer/de-multiplexer (MUX/DEMUX) modules 104 and 108, such as add/drop multiplexers (ADMs), aggregate traffic from the network elements 102a-102e and 110a-110e for transport over an optical fiber 113. Although only a single optical fiber 113 is shown, it is recognized that multiple fibers can be employed in the system 100.

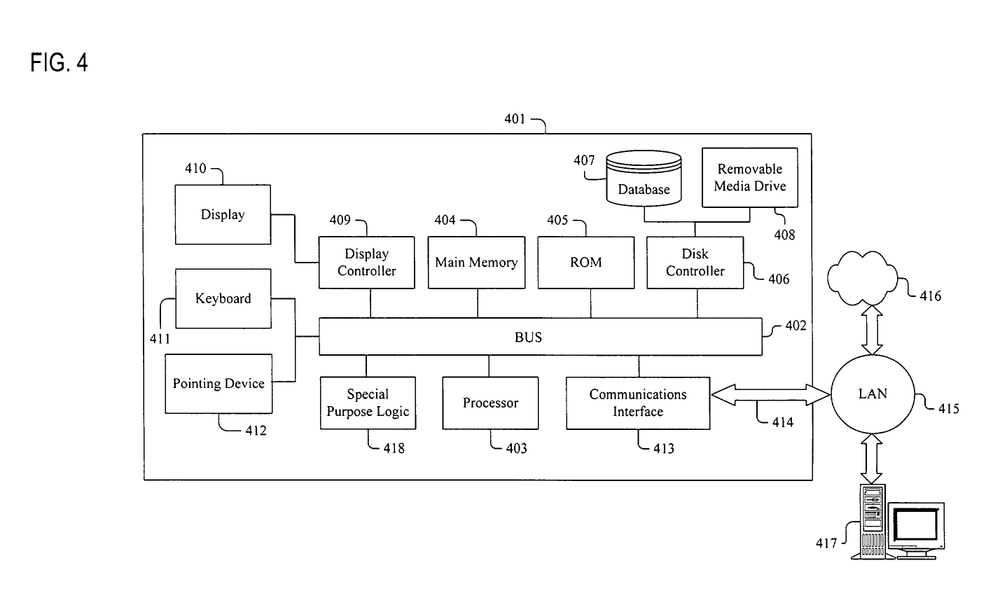

The architecture of FIG. 1 is of an exemplary nature and the present invention is applicable to other optical networks employing optical channels, as will be appreciated by those skilled in the relevant art(s). The system 100 can include any suitable servers, workstations, personal computers (PCs), other devices, etc., capable of performing the processes of the present invention. One or more of the devices shown in FIG. 1 can be implemented using the computer system 401 of FIG. 4, for example. One or more interface mechanisms can be used in the system 100, for example, including Internet access, intranet access, etc. The system 100 of FIG. 1 may be part of a Dense Wavelenghth Division Multiplexed (DWDM) system, wherein the optical fiber 113 carries multiple optical channels at predetermined wavelengths (λ₁ . . . λₙ).

The system 100 of FIG. 1, for instance, can be employed in Long Haul (LH) and Ultra Long Haul (ULH) environments as a backbone network, for example, to connect the network elements 102a-102e (e.g., optical gateways) of one major metropolitan area to the network elements 110a-110e (e.g., optical gateways) of another major metropolitan area.

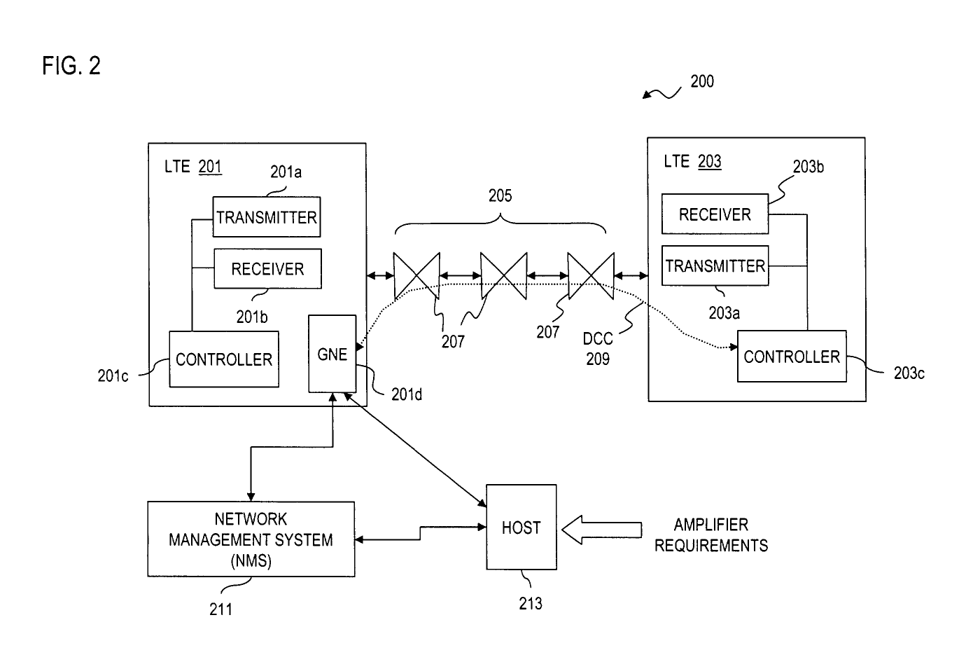

The system 100 provides a gateway network element (GNE), via network element 102a, that controls transmission power levels corresponding to the wavelengths of the system 100 so that the wavelengths are in lock step with each other. This is accomplished by employing a “Q” (i.e., Quality) value and/or a bit error rate (BER) value to control the transmission power levels of the wavelengths, rather than using raw power, which does not distinguish between amplifier noise and signal. The “Q” value measurement is based on a sample of a received signal by a receiver of a Line Terminating Equipment (LTE) (as shown in FIG. 2), in which a decision threshold associated with the sampled signal deviates from an optimum point (i.e., minimal decision errors regarding the interpretation of the bits are introduced) to a point in which decision errors begin to exceed a specified range. Accordingly, an estimated BER corresponding to this sub-optimal point can be derived and sent to the GNE, as the Q value. The GNE can then use the Q value to modify the transmitter power levels to keep the signal at the optimum point.

Employing the Q value and/or the BER value to control the power levels of the wavelengths, advantageously, takes into account the amplifier noise and provides a relatively more accurate system setup. For example, the automatic control of the transmitter power can be based values that can be programmed into the communications system based on, for example, transmission medium requirements, thereby allowing amplifiers to be operate automatically in an “auto control” mode, while the GNE 102a performs this equalization of the power levels.

According to one embodiment of the present invention, the GNE function can reside with the network element 102a. The amplifiers 106a-106e can be generic and employ, according to one embodiment of the present invention, a distribution of no greater than N db (where N corresponds to the number of amplifiers) between the highest and lowest wavelengths. In the system 100, a technician can log onto the GNE and effectively program the amplifier 106a-106e values (e.g, the Q values and the BER values) via a graphical user interface (GUI). The GNE 102a then uses a designated data communications channel (DCC) to inform the network elements 102a-102e and 110a-110e of the amplifier requirements; e.g., the maximum and minimum amplifier levels.

The network elements 102a-102e and 110a-110e then communicate with each other within a predetermined range, adjusting the transmitter levels for the best receiver S/N ratio and/or BER (or Q value), as part of an automatic transmission power level equalization process (which is more fully described below). Using S/N ratio and/or BER testing to equalize the amplifiers 106a-106e is advantageous over using a flat-level adjustment (i.e., based on raw levels). Accordingly, the system 100 allows use of equipment from different vendors on existing amplifier chains due the programming of amplifier values via the GNE 102a, advantageously, providing increased capacity, line termination, and low equipment costs.

The GNE 102a can communicate with a network management system (NMS) 112, which in conjunction with the GNE 102a can monitor the power level equalization process of the system 100. The NMS 112 performs a number of network management functions, including, for example, alarm reporting, end-to-end provisioning, optical layer fault management, and network restoration.

Although one GNE 102a is shown in FIG. 1, the system 100 can employ one or more GNEs to provide feedback regarding operation of elements of the system 100. Furthermore, the GNEs can be employed in Wavelength Division Multiplexing (WDM), Dense Wavelength Division Multiplexing (DWDM), Optical (WDM) Add-Drop Multiplexer (OADM), and Synchronous Optical NETwork (SONET) equipment and can provide automatic control of transmitter power based on one or more of the following exemplary criteria: received error count, and pseudo Q value.

It is to be understood that the system in FIG. 1 is for exemplary purposes only, as many variations of the specific hardware and/or software used to implement the present invention are possible, as will be appreciated by those skilled in the relevant art(s). For example, the functionality of one or more of the devices of the system 100 can be implemented via one or more programmed computer systems or devices. To implement such variations as well as other variations, a single computer (e.g., the computer system 401 of FIG. 4) can be programmed to perform the special purpose functions of one or more of the devices of the system 100 of FIG. 1.

Alternatively, two or more programmed computer systems or devices, for example as in shown FIG. 4, may be substituted for any one of the devices of the system 100 of FIG. 1. Principles and advantages of distributed processing, such as redundancy, replication, etc., can also be implemented as desired to increase the robustness and performance of the system 100, for example.

FIG. 2 is a diagram of a line terminating equipment (LTE) capable of providing gateway network element functionality, according to an embodiment of the present invention. An optical communications system 200 includes two line terminating equipment (LTEs) 201, 203 communicating over an optical span 205 that contains a chain of amplifiers 207. Each of the LTEs 201, 203 include a transmitter 201a, 203a, a receiver 201b, 203b, and a controller 201c, 203c for controlling the transmission of signals to and from the optical span 205. In this scenario, the LTE 201 includes GNE functionality by way of a GNE module 201d.

The GNE module 201d communicates amplifier requirements (e.g., error rate information including Signal-to-Noise (S/N) ratio, bit error rate (BER), and/or Quality (Q) value) to the LTE 203 sing a DCC 209. Additionally, the GNE module 201d communicates with a network management system (NMS) 211 to notify the NMS 211 of the status of the equalization process. A host 213 can access the NMS 211 to supply the amplifier requirements; alternatively, the host 213 can communicate directly with the GNE module 201d to supply these requirements. Technicians can enter the amplifier requirements using a GUI, and then ensure that the elements of the communications system 200 maintain the specified amplifier requirements via the GNEs.

Under the conventional approach, all the transmitters are set to a predetermined level measured at the input of the amplifiers. The levels between each transmitter can be set very close to each other, typically around 0.5 db. This approach, however, requires time-intensive measurements and manual testing by a skilled technician.

Another conventional approach is to place an Optical Spectrum Analyzer (OSA) at outputs of the end ampliers 106a and 106e and to monitor signal-to-noise (S/N) ratio of transmitted signals. The transmitters then can be adjusted to ensure that each wavelength has a same S/N ratio, for example, in a range of about 0.5 db to 1 db. The conventional approach requires expensive test equipment and a highly skilled technician. The system 200 overcomes the limitations of the above-noted conventional techniques by employing such functionality within the line terminating equipment (i.e., network elements), as controlled by the GNE 201d. As a result, manual test procedures can be avoided, thereby reducing costs.

Further, a Q value can be programmed in receiver elements (e.g., receiver 201b) and can be derived, for example, based on circuitry that drives a threshold of the 1's and 0's through decision making thresholds, while maintaining adequate levels of service. When the system 200 is powered up, the technician can program a maximum power level deviation that the amplifiers 106a-106e can tolerate based on an optical S/N ratio (OSNR)-based equalization process. Accordingly, the individual systems can start balancing themselves using feedback from receiver (e.g., receiver 201b) to transmitter (e.g., transmitter 203a) over a data communications channel (DCC) 209.

During the balancing (i.e., equalization) process, the GNE 201d, according to one embodiment of the present invention, can be informed via the NMS 211 of the transmitter levels and the Q values for the associated network elements and can regulate the maximum power level deviation. The GNE 201d also can report the equalization process to a network management system 211 via Transaction Language 1 (TL1) messages and to the technician via a graphical user interface (GUI) on the host 213.

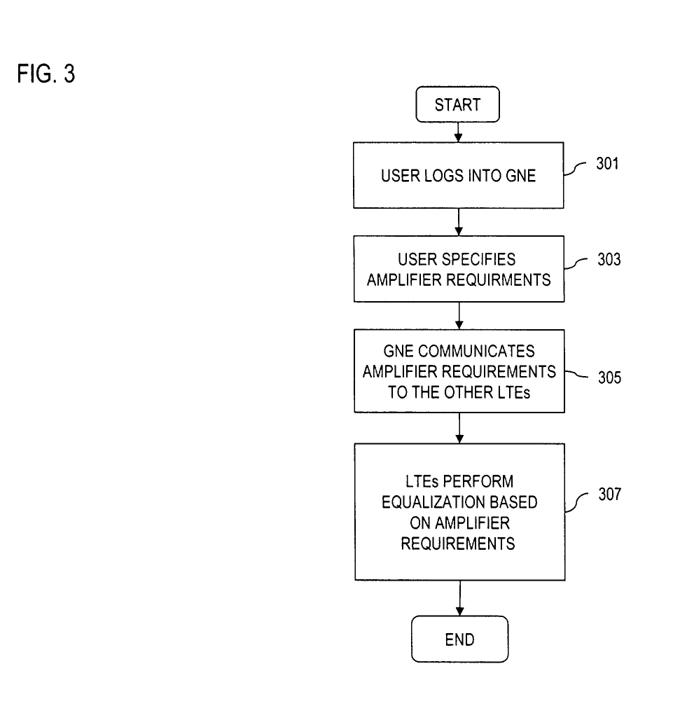

FIG. 3 is a flow chart of the operation of the system of FIG. 2 for performing equalization, according to an embodiment of the present invention. In step 301, a user, such as a technician, logs into the GNE (e.g., GNE module 201d). Upon access into the GNE 201d, the user can specify the amplifier requirements (which can include error rate information including S/N ratio, BER, and/or Quality (Q) value), per step 303. Alternatively, the input amplifier requirements can constitute, for example, the maximum and minimum transmission levels. The GNE 201d then communicates the amplifier requirements, as in step 305, to the LTEs (e.g., LTE 203). Next, as in step 307, the LTE 203 performs equalization based on the amplifier requirements.

The above approach advantageously allows error rates to be optimized at line terminating equipment, allows communications service providers to deploy different vendor equipment on a same amplifier chain (as long as dispersion limitations are compatible), and provides automatic level control and equalization.

According to one embodiment, the present invention stores information relating to various processes described herein. This information is stored in one or more memories, such as a hard disk, optical disk, magneto-optical disk, RAM, etc. One or more databases, such as databases within the devices of the system 100 of FIG. 1 can store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 4, for example.

The previously described processes include appropriate data structures for storing data collected and/or generated by the processes of the system 100 of FIG. 1 in one or more databases thereof. Such data structures accordingly can includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures can use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The embodiments of the present invention (e.g., as described with respect to FIGS. 1-3) can be implemented by the preparation of application-specific integrated circuits or by interconnecting an appropriate network of component circuits, as will be appreciated by those skilled in the electrical art(s). In addition, all or a portion of the invention (e.g., as described with respect to FIGS. 1-3) can be implemented using one or more general purpose computer systems, microprocessors, digital signal processors, micro-controllers, etc., programmed according to the teachings of the present invention (e.g., using the computer system 401 of FIG. 4), as will be appreciated by those skilled in the computer and software art(s). Appropriate software can be readily prepared by programmers of ordinary skill based on the teachings of the present disclosure, as will be appreciated by those skilled in the software art. Further, the present invention can be implemented on the World Wide Web (e.g., using the computer system 401 of FIG. 4).

FIG. 4 shows an exemplary computer system that can be programmed to perform one or more of the processes, in accordance with various embodiments of the present invention. The present invention can be implemented on a single such computer system, or a collection of multiple such computer systems. The computer system 401 includes a bus 402 or other communication mechanism for communicating information, and a processor 403 coupled to the bus 402 for processing the information. The computer system 401 also includes a main memory 404, such as a random access memory (RAM), other dynamic storage device (e.g., dynamic RAM (DRAM), static RAM (SRAM), synchronous DRAM (SDRAM)), etc., coupled to the bus 402 for storing information and instructions to be executed by the processor 403. In addition, the main memory 404 can also be used for storing temporary variables or other intermediate information during the execution of instructions by the processor 403. The computer system 401 further includes a read only memory (ROM) 405 or other static storage device (e.g., programmable ROM (PROM), erasable PROM (EPROM), electrically erasable PROM (EEPROM), etc.) coupled to the bus 402 for storing static information and instructions.

The computer system 401 also includes a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). Such storage devices can be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 can also include special purpose logic devices 418, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, GNE functions, and controller 201c, 203c functions, etc.

The computer system 401 can also include a display controller 409 coupled to the bus 402 to control a display 410, such as a cathode ray tube (CRT), liquid crystal display (LCD), active matrix display, plasma display, touch display, etc., for displaying or conveying information to a computer user. The computer system includes input devices, such as a keyboard 411 including alphanumeric and other keys and a pointing device 412, for interacting with a computer user and providing information to the processor 403. The pointing device 412, for example, can be a mouse, a trackball, a pointing stick, etc., or voice recognition processor, etc., for communicating direction information and command selections to the processor 403 and for controlling cursor movement on the display 410. In addition, a printer can provide printed listings of the data structures/information of the system shown in FIG. 1, or any other data stored and/or generated by the computer system 401.

The computer system 401 performs a portion or all of the processing steps of the invention in response to the processor 403 executing one or more sequences of one or more instructions contained in a memory, such as the main memory 404. Such instructions can be read into the main memory 404 from another computer readable medium, such as a hard disk 407 or a removable media drive 408. Execution of the arrangement of instructions contained in the main memory 404 causes the processor 403 to perform the process steps described herein. One or more processors in a multi-processing arrangement can also be employed to execute the sequences of instructions contained in main memory 404. In alternative embodiments, hardwired circuitry can be used in place of or in combination with software instructions. Thus, embodiments are not limited to any specific combination of hardware circuitry and software.

Stored on any one or on a combination of computer readable media, the present invention includes software for controlling the computer system 401, for driving a device or devices for implementing the invention, and for enabling the computer system 401 to interact with a human user (e.g., users of the system 100 of FIG. 1, etc.). Such software can include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention can be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention can be distributed for better performance, reliability, and/or cost.

The computer system 401 also includes a communication interface 413 coupled to the bus 402. The communication interface 413 provides a two-way data communication coupling to a network link 414 that is connected to, for example, a local area network (LAN) 415, or to another communications network 416 such as the Internet. For example, the communication interface 413 can be a digital subscriber line (DSL) card or modem, an integrated services digital network (ISDN) card, a cable modem, a telephone modem, etc., to provide a data communication connection to a corresponding type of telephone line. As another example, communication interface 413 can be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 413 sends and receives electrical, electromagnetic, or optical signals that carry digital data streams representing various types of information. Further, the communication interface 413 can include peripheral interface devices, such as a Universal Serial Bus (USB) interface, a PCMCIA (Personal Computer Memory Card International Association) interface, etc.

The network link 414 typically provides data communication through one or more networks to other data devices. For example, the network link 414 can provide a connection through local area network (LAN) 415 to a host computer 417, which has connectivity to a network 416 (e.g. a wide area network (WAN) or the global packet data communication network now commonly referred to as the “Internet”) or to data equipment operated by service provider. The local network 415 and network 416 both use electrical, electromagnetic, or optical signals to convey information and instructions. The signals through the various networks and the signals on network link 414 and through communication interface 413, which communicate digital data with computer system 401, are exemplary forms of carrier waves bearing the information and instructions.

The computer system 401 can send messages and receive data, including program code, through the network(s), network link 414, and communication interface 413. In the Internet example, a server (not shown) might transmit requested code belonging to an application program for implementing an embodiment of the present invention through the network 416, LAN 415 and communication interface 413. The processor 403 can execute the transmitted code while being received and/or store the code in storage devices 407 or 408, or other non-volatile storage for later execution. In this manner, computer system 401 can obtain application code in the form of a carrier wave. With the system of FIG. 4, the present invention can be implemented on the Internet as a Web Server 401 performing one or more of the processes according to the present invention for one or more computers coupled to the Web server 401 through the network 416 coupled to the network link 414.

The term “computer readable medium” as used herein refers to any medium that participates in providing instructions to the processor 403 for execution. Such a medium can take many forms, including but not limited to, non-volatile media, volatile media, transmission media, etc. Non-volatile media include, for example, optical or magnetic disks, magneto-optical disks, etc., such as the hard disk 407 or the removable media drive 408. Volatile media include dynamic memory, etc., such as the main memory 404. Transmission media include coaxial cables, copper wire, fiber optics, including the wires that make up the bus 402. Transmission media can also take the form of acoustic, optical, or electromagnetic waves, such as those generated during radio frequency (RF) and infrared (IR) data communications. As stated above, the computer system 401 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the present invention can initially be borne on a magnetic disk of a remote computer connected to either of networks 415 and 416. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Accordingly, the present invention provides a gateway network element that communicates amplifier requirements (e.g., Signal to Noise (S/N) ratio, bit error rate (BER), Q value, etc.) which can be based on error rates, to another network element for automatically controlling the transmission level across an optical amplifier chain. This arrangement advantageously enhances network performance and improves system efficiency.

While the present invention has been described in connection with a number of embodiments and implementations, the present invention is not so limited, but rather covers various modifications and equivalent arrangements, which fall within the purview of the appended claims.

What is claimed is:

1. A method for providing transmission level control in an optical network having an amplifier chain, the method comprising:
receiving an amplifier requirement from a host; and
forwarding the amplifier requirement to a network element in the optical network, wherein the network element adjusts transmission power level in response to the amplifier requirement.

2. A method according to claim 1, further comprising:
adjusting power level of a transmitter according to the received amplifier requirement.

3. A method according to claim 2, wherein the amplifier requirement in the receiving step includes at least one of a signal-to-noise level, an error rate, and a Quality (Q) value that corresponds to a level of signal decision errors.

4. A method according to claim 1, further comprising:
monitoring received signals transmitted across the amplifier chain to determine deviation from the amplifier requirement.

5. A method according to claim 4, further comprising:
communicating with a network management system to convey information on the transmission level equalization process of the optical network.

6. A network device for providing transmission level control in an optical network having an amplifier chain, the device comprising:
logic configured to receive an amplifier requirement from a host; and
a controller coupled to the logic and configured to control a transmitter, wherein the transmitter is configured to forward the amplifier requirement to a network element in the optical network, and the network element adjusts transmission power level in response to the amplifier requirement.

7. A device according to claim 6, wherein the logic is further configured to instruct the controller to adjust power level of the transmitter according to the determined performance parameter.

8. A device according to claim 7, wherein the amplifier requirement includes at least one of a signal-to-noise level, an error rate, and a Quality (Q) value that corresponds to a level of signal decision errors.

9. A device according to claim 6, wherein the logic is further configured to monitor received signals transmitted across the amplifier chain to determine deviation from the amplifier requirements.

10. A device according to claim 9, wherein the logic is further configured to communicate with a network management device to convey information on the transmission level equalization process of the optical network.

11. A system for providing transmission level control in an optical network having an amplifier chain, the system comprising:
means for receiving an amplifier requirement from a host; and
means for forwarding the amplifier requirement to a network element in the optical network, wherein the network element adjusts transmission power level in response to the amplifier requirement.

12. A system according to claim 11, further comprising:
means for adjusting power level of a transmitter according to the received amplifier requirement.

13. A system according to claim 12, wherein the amplifier requirement includes at least one of a signal-to-noise level, an error rate, and a Quality (Q) value that corresponds to a level of signal decision errors.

14. A system according to claim 11, further comprising:
means for monitoring received signals transmitted across the amplifier chain to determine deviation from the amplifier requirements.

15. A system according to claim 14, further comprising:
means for communicating with a network management system to convey information on the transmission level equalization process of the optical network.

16. An optical communications system comprising:
a first network element configured to receive an amplifier requirement from a host; and
a second network element communicating with the first network element over an amplifier chain, the second network element being configured to receive the amplifier requirement from the first network element, and to adjust transmission power level in response to the received amplifier requirement.

17. A system according to claim 16, wherein the amplifier requirement includes at least one of a signal-to-noise level, an error rate, and a Quality (Q) value that corresponds to a level of signal decision errors.

18. A system according to claim 16, wherein the first network element is further configured to monitor received signals transmitted across the amplifier chain to determine deviation from the amplifier requirement.

19. A system according to claim 16, wherein the first network element is further configured to communicate with a network management system to convey information on the transmission level equalization process of the optical network.

20. A method for providing transmission level control in an optical network, the method comprising:
accessing a gateway network element associated with a line terminating equipment of the optical network; and
transmitting an amplifier requirement to the gateway network element, wherein the gateway network element forwards the amplifier requirement to another line terminating equipment over an amplifier chain in the optical network, the other line terminating equipment adjusting transmission power level in response to the amplifier requirement.

21. A method according to claim 20, further comprising:
instructing the gateway network element to adjust power level of a transmitter according to the amplifier requirement.

22. A method according to claim 21, wherein the amplifier requirement in the transmitting step includes at least one of a signal-to-noise level, an error rate, and a Quality (Q) value that corresponds to a level of signal decision errors.

23. A method according to claim 20, further comprising:
monitoring signals transmitted across the amplifier chain and received by the gateway network element to determine deviation from the amplifier requirements.

24. A computer-readable medium carrying one or more sequences of one or more instructions for providing transmission level control in an optical network, the one or more sequences of one or more instructions including instructions which, when executed by one or more processors, cause the one or more processors to perform the steps of:
accessing a gateway network element associated with a line terminating equipment of the optical network; and
transmitting an amplifier requirement to the gateway network element, wherein the gateway network element forwards the amplifier requirement to another line terminating equipment over an amplifier chain in the optical network, the other line terminating equipment adjusting transmission power level in response to the amplifier requirement.

25. A computer-readable medium according to claim 24, wherein the one or more processors further perform the step of:
instructing the gateway network element to adjust power level of a transmitter according to the amplifier parameter.

26. A computer-readable medium according to claim 25, wherein the amplifier requirement in the transmitting step includes at least one of a signal-to-noise level, an error rate, and a Quality (Q) value that corresponds to a level of signal decision errors.

27. A computer-readable medium according to claim 24, wherein the one or more processors further perform the step of:
monitoring signals transmitted across the amplifier chain and received by the gateway network element to determine deviation from the amplifier requirement.
